(19) United States
(12) Patent Application Publication
(10) Pub. No.: US 2010/0057397 A1
(43) Pub. Date: Mar. 4, 2010

(54) BODY MOTION DETECTION DEVICE HAVING FEWER NUMBER OF SWITCHES NECESSARY FOR A SETTING OPERATION

(75) Inventors: Naoki Takeishi, Osaka (JP); Kenji Hashino, Osaka (JP); Taiga Sato, Kyoto (JP); Yasuyuki Togoe, Shiga (JP)

Correspondence Address: MORRISON & FOERSTER LLP, 1650 TYSONS BOULEVARD, SUITE 400, MCLEAN, VA, 22102, US

(73) Assignee: OMRON HEALTHCARE Co., Ltd, Kyoto-shi (JP)

(21) Appl. No.: 12/514,408

(22) PCT Filed: Oct. 24, 2007
(86) PCT No.: PCT/JP2007/070718

§ 371 Date: Jun. 4, 2009

(30) Foreign Application Priority Data
Nov. 21, 2006 (JP) 2006-314385

(51) Int. Cl. G01C 22/00

(52) U.S. Cl. 702/160

(57) ABSTRACT

A pedometer can be equipped with a sensor unit including a sensor for detecting motion by detecting acceleration of a displacement of a main body. Detected acceleration can be compared with a threshold value to determine whether the acceleration corresponds to body motion or to a setting operation. Various setting operations can be performed based on shaking of the pedometer.

### REFERENCE TO RELATED APPLICATIONS

This application is a national stage application under 35 USC 371 of International Application No. PCT/JP2007/070718, filed Oct. 24, 2007, which claims the priority of Japanese Patent Application No. 2006-314385, filed Nov. 21, 2006, the contents of which prior applications are incorporated herein by reference.

### FIELD OF THE INVENTION

The present invention relates to a body motion detection device, in particular, to a pedometer capable of counting the number of steps by detecting body motion of a body.

### BACKGROUND OF THE INVENTION

A pedometer for detecting body motion of a body by being attached to clothes and the like, and measuring the number of steps therefrom is conventionally known. In such a pedometer, a body motion detection sensor serving as body motion detection means for detecting the body motion of the body is used. The body motion detection sensor that uses a piezoelectric element or that uses a pendulum is known.

In such a conventional pedometer, at least two switches, a switch for selecting a numeric value and a switch for determining a numeric value, are required for setting clock information and personal information. Specifically, FIG. 11 shows and describes a pedometer 10 disclosed in Japanese Unexamined Patent Publication No. 10-258042 (hereinafter referred to as Patent Document 1) filed and publicized earlier by the applicant of the present application.

With reference to FIG. 11, the pedometer 10 has a mode switch 13, a set switch 14, and an upward arrow switch 15. During the clock setting or the body information setting, the clock and the body information are set by selecting a set value with the upward arrow switch 15 and determining the value with the set switch 14. A display is switched by operating the mode switch 13 while walking.

[Patent Document 1] Japanese Unexamined Patent Publication No. 10-258042

### SUMMARY OF THE INVENTION

However, in an operation method used in a conventional pedometer such as a pedometer 10 disclosed in Patent Document 1, at least two switches, a switch for selecting a numeric value and a switch for determining a numeric value, need to be arranged in the pedometer. Thus, there is a problem in that miniaturization of a main body is prevented. In addition, a manufacturing cost may increase. Furthermore, the operation may become complicated.

The present invention is provided in view of the above problems, and an object of the present invention is to provide a body motion detection device in which the number of switches necessary for various types of setting operations such as a setting operation of clock information and a setting operation of body information is less than a conventional pedometer.

To achieve the above object, in accordance with one aspect of the present invention, a body motion detection device includes: a main body; an acceleration sensor for detecting acceleration of the main body; a storage section for storing a range of acceleration of having the detected acceleration as body motion, and a threshold value for determining whether or not the detected acceleration greater than the range of acceleration is operation for setting operation; a vibration determination section for determining that the detected acceleration is due to body motion when the acceleration detected by the acceleration sensor is within the range, and determining that the detected acceleration is due to an operation for the setting operation when the acceleration detected by the acceleration sensor is greater than the threshold value; a body motion detecting section for detecting the body motion based on the acceleration detected by the acceleration sensor when determined that the acceleration detected by the acceleration sensor is due to body motion; a counting section for counting the number of the body motion; and a setting operation section for performing the setting operation when determined that the acceleration detected by the acceleration sensor is due to the operation for the setting operation. The pedometer is given as an example of the body motion detection device, where the number of steps of a subject is counted by detecting the acceleration of the main body involved in walking and running of the subject to which it is attached.

As the body motion detection device according to the present invention has the above-described configuration, the body motion detection device can be miniaturized and the cost can be reduced.

### BRIEF DESCRIPTION OF THE DRAWINGS

FIG. 1 is a schematic view showing a state in which a user wears a pedometer according to the present embodiment.

FIG. 2 is a perspective view of when the pedometer according to the present embodiment is seen from a diagonally upper right side of a front side.

FIG. 3 is a side view of when the pedometer according to the present embodiment is seen from a right side.

FIG. 4 is a block diagram showing a specific example of a device configuration of the pedometer according to the present embodiment.

FIG. 5 is a block diagram showing a specific example of a function configuration of the pedometer according to the present embodiment.

FIG. 6 is a view showing a specific example of an acceleration waveform.

FIG. 7 is a view showing a specific example of mode transition.

FIG. 8 is a flowchart showing a specific example of a setting process using an acceleration switch.

FIG. 9 is a flowchart showing a specific example of an operation process using the acceleration switch.

FIG. 10 is a view describing a body motion detection sensor of a pedometer according to a second modification.

FIG. 11 is a view describing a conventional pedometer.

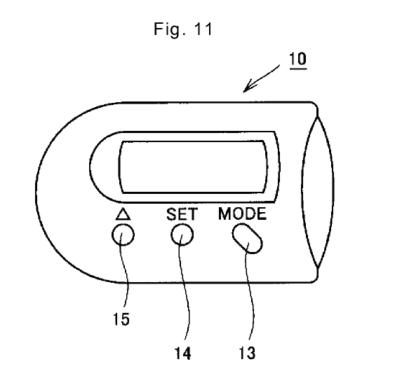

### DETAILED DESCRIPTION OF THE INVENTION

Hereinafter, an embodiment of the present invention will be described with reference to the drawings. In the following description, the same reference symbols are denoted for the same parts and components. Names and functions thereof are also the same.

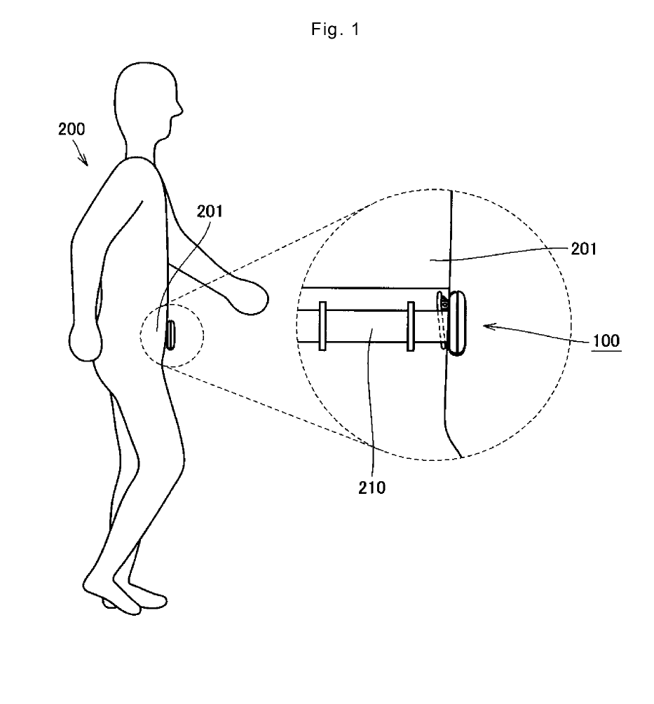

FIG. 1 is a schematic view showing a state in which a user 200 wears a pedometer 100 according to the embodiment of the present invention. The pedometer 100 according to the present embodiment is intended to be attached to clothes. Specifically, the pedometer 100 is intended to be attached to a belt 210 wrapped around a hip 201 of the user 200 as shown in FIG. 1, or to be attached to clothes such as pants, skirts, or the like. The pedometer 100 is formed such that an outer shape thereof is a flat shape, that is, thin so that it does not project out towards a front side more than necessary from the hip 201 of the user 200 in the attached state and become an obstacle to the user.

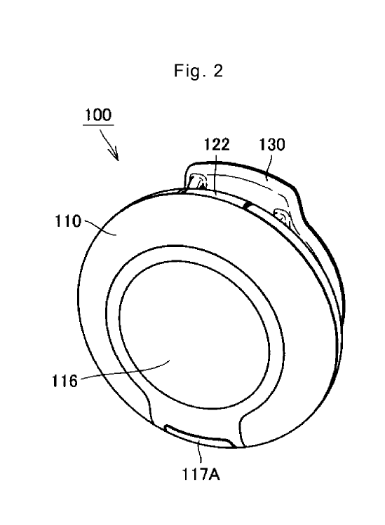

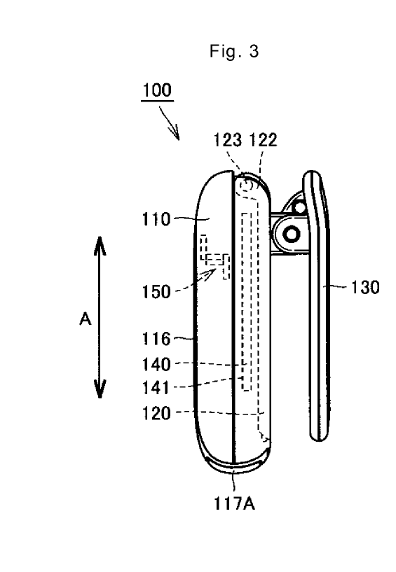

FIGS. 2 and 3 are views showing an outer appearance structure of the pedometer 100 according to the present embodiment. FIG. 2 is a perspective view of when the pedometer 100 according to the present embodiment is seen from a diagonally upper right side of a front side. FIG. 3 is a side view of when the pedometer 100 according to the present embodiment is seen from a right side. As shown in FIGS. 2 and 3, the pedometer 100 according to the present embodiment mainly includes a main body 110, and a base section 120 and a clip section 130 serving as an attachment section.

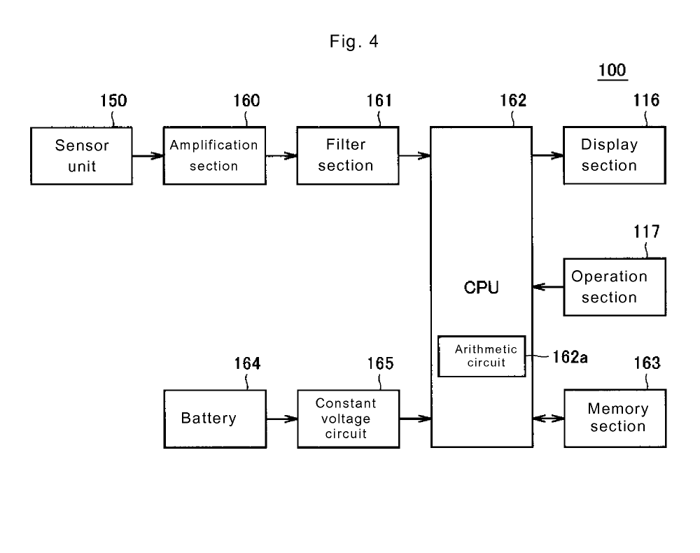

The main body 110 has an outer shape of a circular flat shape in front view. A display section 116 is provided on a front surface thereof, and a set switch 117A is provided at a lower part of a peripheral surface thereof. The display section 116 is display means for displaying body motion information detected by a sensor unit 150 corresponding to vibration detection means including a body motion detection sensor 150A (not shown), and is suitable configured by a liquid crystal display panel (LCD). The set switch 117A is used as a power switch for turning ON the power, a reset switch for resetting a counter, a set switch for performing various settings, and the like. The set switch 117A constitutes an operation section 117 (see FIG. 4) for executing various processing operations and the like by accepting the operation of the user.

A body motion detection sensor 150A of the sensor unit 150, a circuit substrate arranged with a processing circuit and the like for performing various types of processing operations based on the signal outputted from the body motion detection sensor 150A, a battery 164 (see FIG. 4) for supplying power to the processing circuits, and the like are accommodated inside the main body 110. A recessed portion for accommodating the base section 120 is formed on a rear surface of the main body 110.

The base section 120 is configured by a substantially circular plate-shaped member having an opening at a central part. The clip section 130 is configured by a substantially circular plate-shaped member having an opening at a central part. The base section 120 and the clip section 130 are turnably coupled. Note that a coil spring (not shown) for biasing in a direction of approaching the base section 120 and the clip section 130 is arranged between the base section 120 and the clip section 130. The clothing such as a belt or the like is sandwiched and held by the base section 120 and the clip section 130 by a biasing force of the coil spring.

A tongue-shaped portion 122 projecting upward is arranged at an upper part of the base section 120. The main body 110 and the base section 120 are coupled in a freely turning manner by a turning shaft 123 arranged at the tongue-shaped portion 122. Thus, the main body 110 can take a non-turning state in which the base section 120 is accommodated in the recessed portion formed at the rear surface of the main body 110, and a turning state of turning in a direction of moving away from the base section 120. In the non-turning state, the front surface of the base section 120 and the front surface of the main body 110 are arranged substantially parallel, where the display section 116 arranged on the front surface of the main body 110 is positioned exposed towards the front side when seen from the user.

The above-described sensor unit 150 corresponding to the vibration detection means is included inside the main body 110 of the pedometer 100. One example of a configuration of the body motion detection sensor 150A of the sensor unit 150 includes a structure including a plate-shaped member having a cantilever structure and a piezoelectric element attached to this plate-shaped member as a configuration of a general acceleration sensor. The sensor unit 150 including the body motion detection sensor 150A or the acceleration sensor having such a structure detects a vibration in the following mechanism. A deflection occurs at a beam portion of the plate-shaped member according to a displacement (vibration) of the main body 110 due to the body motion and the like of the user. A distortion generates at the piezoelectric element with the deflection of the beam portion, and an electric signal corresponding to such a distortion is inputted to various types of circuits to be hereinafter described. The displacement (vibration) of the main body 110 with respect to a detection axis direction is detected by such an electric signal.

When the sensor unit 150 includes the body motion detection sensor 150A of such a configuration, a printed circuit board 140 serving as a wiring substrate is accommodated and fixed inside the main body 110, as shown in FIG. 3. The sensor unit 150 is attached to a mounting surface 141, which is one of main surfaces of the printed circuit board 140. In FIG. 3, a case where the sensor unit 150 is attached to the main surface of the printed circuit board 140 on a side not facing the attachment surface of the main body 110, but it may be attached to the main surface of the printed circuit board 140 on a side facing the attachment surface.

The assembly structure of the sensor unit 150 having the above configuration to the printed circuit board 140 is not limited to a specific structure in the present invention. The configuration of the body motion detection sensor 150A of the sensor unit 150 has been described illustrating a case of being configured by the plate-shaped member having a cantilever structure and the piezoelectric element in the above example, but is not limited to such a specific configuration in the present invention. For example, a sensor unit of a pendulum type may be used for the vibration detection means.

FIG. 4 is a block diagram showing a specific example of a device configuration of the pedometer 100 according to the present embodiment.

With reference to FIG. 4, the pedometer 100 according to the present embodiment is configured to include an amplification section 160, a filter section 161, a CPU (Central Processing Unit) 162, a memory section 163, a battery 164, and a constant voltage circuit 165 in addition to the display section 116, the operation section 117, and the sensor unit 150.

The amplification section 160 includes a circuit for amplifying the electric signal output from the sensor unit 150. The filter section 161 includes a circuit for removing a noise contained in the amplified electric signal outputted from the amplification section 160.

A program for performing various arithmetic processing is stored in a predetermined region of the memory section 163. The CPU 162 reads out and executes a program stored in the memory section 163 according to the signal inputted from the operation section 117, and counts the number of steps using the electric signal outputted from the filter section 161. The CPU 162 includes an arithmetic circuit 162a for counting the number of steps by performing various arithmetical operations using the electric signal outputted from the filter section 161. The arithmetic circuit 162a includes timing means (not shown) to time the current time, a date and time, and the like. Various information such as a measurement result and body information of the user are stored in the predetermined region of the memory 163. The CPU 162 executes the program to output a control signal for displaying various information such as the measurement result on the display section 116.

The battery 164 is a power supply for supplying power to the CPU 162. The constant voltage circuit 165 is a circuit for stabilizing the power supply voltage supplied from the battery 164.

In the pedometer 100 according to the present embodiment, various operations and settings are carried out by shaking the main body 110 in a direction of an arrow A in FIG. 3, which is the direction corresponding to the detection axis of the sensor unit 150. In the following description, shaking the main body 110 in the direction of the arrow A in FIG. 3 to carry out various operations and settings is referred to as “operating an acceleration switch”.

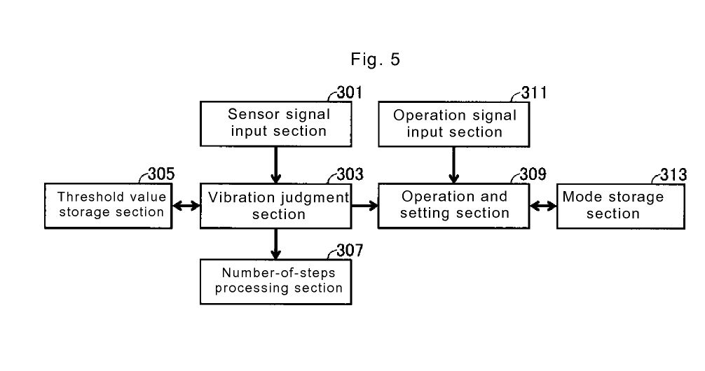

FIG. 5 is a block diagram showing a specific example of a function configuration for carrying out various operations and settings by operating the acceleration switch of the pedometer 100 according to the present embodiment. Each function shown in FIG. 5 is mainly developed on the CPU 162 by having the CPU 162 of the pedometer 100 read out and execute the program stored in the memory section 163 and controlling each section shown in FIG. 4. At least a part of the function may be developed in the device shown in FIG. 4.

With reference to FIG. 5, the function of the pedometer 100 according to the present embodiment is configured to include a sensor signal input section 301 in which a sensor signal or an electric signal outputted from the filter section 161 is inputted, a vibration determination section 303 for determining the content of the vibration based on the sensor signal, a threshold value storage section 305 for storing a threshold value used in the determination in the vibration determination section 303, a number-of-steps processing section 307 for performing a process of counting the number of steps, an operation signal input section 311 in which the operation signal from the operation section 117 is inputted, an operation and setting section 309 for carrying out the operation and the setting based on the sensor signal and the operation signal, and a mode storage section 313 for storing a mode transition defined in advance.

In the present embodiment, when receiving the sensor signal from the filter section 161, the sensor signal input section 301 inputs the same to the vibration determination section 303. In the present embodiment, the vibration determination section 303 performs a first derivation on a displacement waveform representing a relationship between a lapse of time and the displacement of the main body 110 obtained from the inputted sensor signal, and obtains an acceleration waveform of the displacement of the main body 110.

The threshold value storage section 305 stores a threshold value P. The threshold value P is used to determine that the acceleration of the displacement of the main body 110 is the acceleration caused by operating the acceleration switch, that is, the acceleration caused by shaking the main body 110 for operation and setting. A specific numerical value of the threshold value P is preferably about ±3 G (=9.8 m/sec²).

When detecting that amplitude of the acceleration waveform is smaller than the threshold value P using the threshold value P stored in the threshold value storage section 305, the vibration determination section 303 determines that there is body motion of a measuring target such as walking motion or running motion of the user. The vibration determination section 303 then outputs a signal indicating such determination to the number-of-steps processing section 307. The number-of-steps processing section 307 performs a process of counting the body motion, that is, counting the number of steps of the user based on the signal and displaying the same, and a process of calculating a ratio of the counted number of steps with respect to a set target value. A process in the number-of-steps processing section 307 is not limited to a specific process in the present invention, and may be a process in a general pedometer.

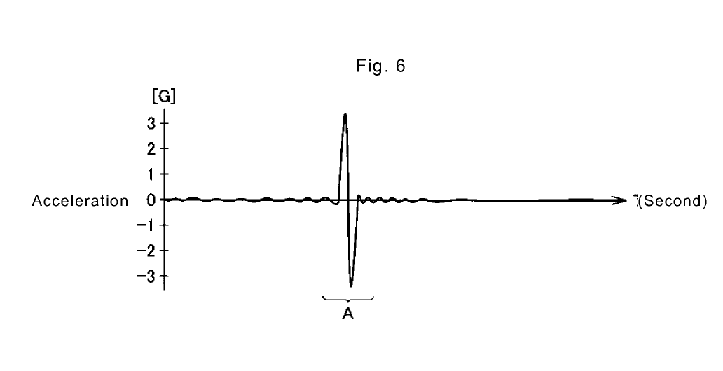

When detecting that the amplitude of the acceleration waveform is not less than the threshold value P, the vibration determination section 303 determines that the acceleration switch has been operated. The vibration determination section 303 then outputs a signal indicating such determination to the operation and setting section 309. The vibration determination section 303 determines that the acceleration switch has been operated at a point A at where the amplitude of not less than the threshold value P is detected when the acceleration waveform as shown in FIG. 6 is obtained.

In the present embodiment, the threshold value storage section 305 stores the threshold value P used in determining whether or not the acceleration is caused by operating the acceleration switch, but the threshold value storage section 305 may also store threshold values P1, P2 used to determine whether or not the acceleration of the displacement of the main body 110 is the body motion. A specific numerical value of the threshold value P1 is preferably about ±0.5 G, and a specific numerical value of the threshold value P2 is about ±2.5 G. In this case, the vibration determination section 303 determines that there is body motion of the measuring target when detecting that the amplitude of the acceleration waveform is within a range of the threshold value P1 to the threshold value P2. Determination is made that the acceleration switch has been operated when detecting that the amplitude of the acceleration waveform is not less than the threshold value P.

Normally, various operations and setting operations are not carried out during the walking motion, and the like, and are carried out when there is no body motion such as during the walking motion. Thus, the vibration determination section 303 may further determine that the acceleration switch has been operated when detecting the amplitude of the acceleration waveform of not less than the threshold value P when the acceleration is 0 G.

Based on the signal indicating the operation of the acceleration switch, and the current mode stored in the mode storage section 313, the operation and setting section 309 selects a value that may be set at the relevant mode. The operation and setting section 309 determines the selected value for the set value of the current mode based on the operation signal representing the operation of the set switch 117A inputted from the operation signal input section 311 and the current mode stored in the mode storage section 313. With reference to a predefined mode transition stored in the mode storage section 313, the current mode transitions to the next mode, and the transitioned mode is stored in the mode storage section 313.

Thus, the acceleration switch is used as means for selecting a value of an item to set in the relevant mode. The set switch 117A is used as instructing means for instructing the mode transition, and also as means for determining the selected value as the set value of the item to set in the relevant mode.

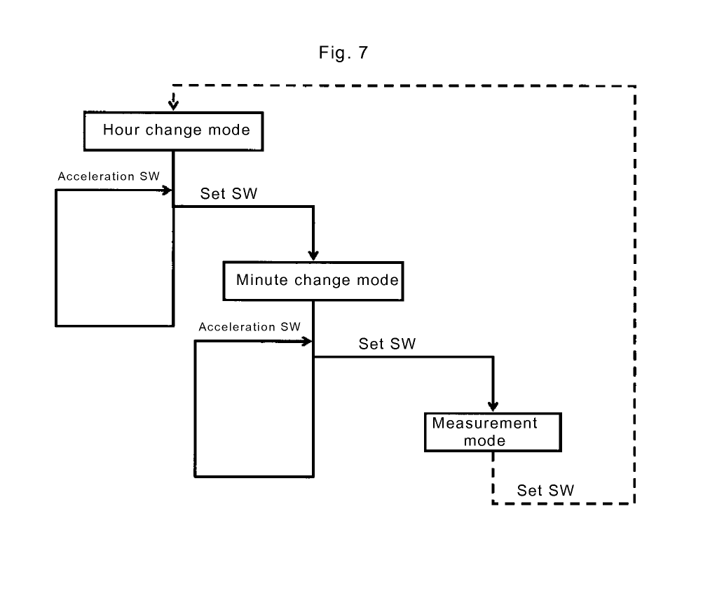

One example of the defined mode transition stored in the mode storage section 313 is shown in FIG. 7, and a specific mode transition will be described. The transition of modes is defined based on the current mode and the signal based on operation such as the sensor signal and the operation signal. In the pedometer 100, when a battery is inserted and the power is turned ON, a setting mode for setting current time is obtained. The mode transition shown in FIG. 7 shows a mode transition within the setting mode and the transition to a measurement mode after the termination of the setting mode.

With reference to FIG. 7, the mode immediately after the power is turned ON is defined as an “hour change mode”. The “hour change mode” is a mode for changing the “hour” of a clock function. In the “hour change mode”, 1 is added to the currently selected “hour” according to the operation of the acceleration switch, and displayed as a value of the “hour” that may be set. In the following description, 1 is added to the currently set “hour” according to the operation of the acceleration switch, but it may also be subtracted.

The “hour change mode” transitions to a “minute change mode” when the set switch 117A is pressed in the “hour change mode”. The “minute change mode” is a mode for changing the “minute”. In the “minute change mode”, 1 is added to the currently selected “minute” according to the operation of the acceleration switch, and displayed as a value of the “minute” that may be set. In the following description, 1 is added to the currently set “minute” according to the operation of the acceleration switch, but it may also be subtracted.

The “minute change mode” transitions to the “measurement mode” of measuring the number of steps when the set switch 117A is pressed in the “minute change mode”. The “measurement mode” is a mode of detecting the body motion of the user and measuring the number of steps.

The mode transition in setting the time is not limited to the transition shown in FIG. 7, and the setting of the “hour” and the setting of the “minute” may be reversed. Furthermore, the date, year/month/day, and day of the week may be set prior to the setting of the time.

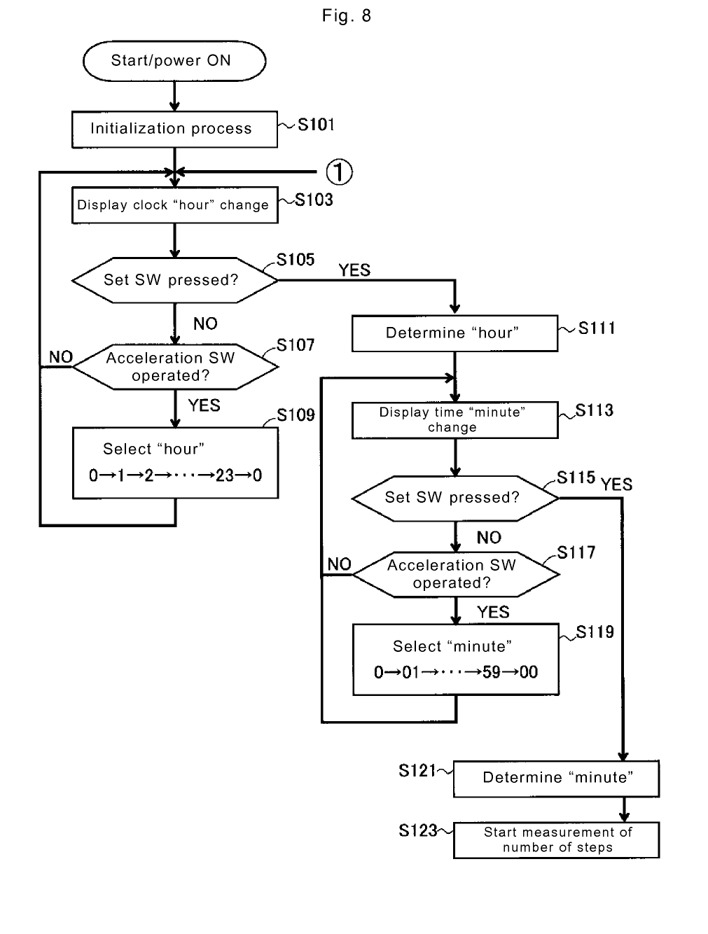

FIG. 8 is a flowchart showing a specific example of a setting process using the acceleration switch in the pedometer 100 according to the present embodiment. The process shown in the flowchart of FIG. 8 is a process executed when the battery is inserted to the pedometer 100 and the power is turned ON, and is realized by having the CPU 162 read out and execute the program stored in the memory section 163, and control each section shown in FIG. 5.

With reference to FIG. 8, when the battery is inserted and the power is turned ON, the CPU 162 first executes an initialization process such as clearing data stored in the memory section 163 (step S101). Thereafter, the operation and setting section 309 transitions to the “hour change mode” according to the mode transition stored in the mode storage section 313, and stores it in the mode storage section 313. When transitioned to the “hour change mode”, the operation and setting section 309 displays that it is currently the mode of changing the “hour” by flashing the “hour” of the initial time displayed on the display section 116 (step S103).

When the vibration determination section 303 detects that the acceleration switch has been operated in the “hour change mode” (NO in step S105, YES in step S107), the operation and setting section 309 adds 1 to the currently displayed “hour” according to such an operation, and displays the relevant value as the value of the selected “hour” (step S109). In the “hour change mode”, the operation and setting section 309 adds 1 to the “hour” and displays the relevant value as the selected value every time the vibration determination section 303 detects the operation of the acceleration switch.

When the operation signal caused by the pressing of the set switch 117A is inputted by the operation signal input section 311 (YES in step S105) in the “hour change mode”, the operation and setting section 309 determines the value of the selected “hour” being displayed at the time as the “hour” to set (step S111). The operation and setting section 309 then transitions from the “hour change mode” to the “minute change mode” according to the mode transition stored in the mode storage section 313, and stores it in the mode storage section 313. When transitioned to the “minute change mode”, the operation and setting section 309 displays that it is currently the mode of changing the “minute” by flashing the “minute” of the time displayed on the display section 116 (step S113).

When the vibration determination section 303 detects that the acceleration switch has been operated in the “minute change mode” (NO in step S115, YES in step S117), the operation and setting section 309 adds 1 to the currently displayed “minute” according to such an operation, and displays the relevant value as the value of the selected “minute” (step S119). In the “minute change mode”, the operation and setting section 309 adds 1 to the “minute” and displays the relevant value as the selected value every time the vibration determination section 303 detects the operation of the acceleration switch.

When the operation signal caused by the pressing of the set switch 117A is inputted by the operation signal input section 311 (YES in step S115) in the “minute change mode”, the operation and setting section 309 determines the value of the selected “minute” being displayed at the time as the “minute” to set (step S121). The operation and setting section 309 then transitions from the “minute change mode” to the “measurement mode” according to the mode transition stored in the mode storage section 313, and stores it the mode storage section 313. When transitioned to the “measurement mode”, the process of measuring the number of steps starts.

In the above description, the process of setting the time using the acceleration switch has been described as the setting process in the pedometer 100 according to the present embodiment, but the item to be set in such a process is not limited to clock information such as time, and may be at least one or more of body information such as a weight, a height, a stride, an age, a gender, or the like of the measurer. It may also be a target value of at least one or more of an amount of exercise such as the number of steps and consumed calories calculated from the number of steps, a walking distance, a burning fat amount, a walking speed, a walking pitch, an exercise intensity, and the number of steps when walking at a certain exercise intensity or more.

When setting the item other than the clock information using the acceleration switch, the mode storage section 313 similarly stores the transition caused by the pressing of the set switch 117A of the mode accepting the change of each item. In each mode, as the vibration determination section 303 detects that the acceleration switch has been operated, the operation and setting section 309 adds (or subtracts) a set value for the item that can be changed at the relevant mode according to the number of operations and selects the same, similar to the process of setting the time. The operation and setting section 309 determines the selected value as the item to be set at the relevant mode and transitions to the next mode when the set switch 117A is pressed.

In the above description, the process of setting the clock information and the like in the setting mode has been described, but if a plurality of modes such as a “walking mode” of measuring the number of steps at the time of normal walking, a “running mode” of measuring the stride at the time of running, a “stair mode” of measuring the number of steps at the time of going up or down the stairs, and a “climbing mode” of measuring the number of steps at the time of climbing is provided in the measurement mode, the process of selecting and setting such modes as the mode to measure may be carried out. In this case, the selected mode is set and a region and the like of a memory for storing the body information such as the stride used in the relevant mode and the information on the number of steps obtained by measuring is set in the setting process.

As such a setting process is performed in the pedometer 100 according to the present embodiment, the number of switches necessary for the setting operation becomes less than in the pedometer for performing the setting operation using the switch of the related art. The above-described process can be realized without newly adding a configuration for the setting process since the body motion detection sensor 150A for detecting the body motion in the pedometer is also used for the setting process. This contributes to miniaturization and lower cost.

Various settings are possible by combining the pressing of the set switch 117A and the shaking of the pedometer 100 in a predetermined direction, and thus the operation is easier than the operation of the conventional pedometer in which a plurality of switches are pressed for different purposes. Therefore, a pedometer that is easy to use for wide range of users can be provided.

### [First Modification]

In the above description, the setting process is performed using the acceleration switch in the setting mode of before transitioning to the measurement mode in the pedometer 100 according to the present embodiment, but the present invention is not limited to the setting process in the setting mode, and other operations may be performed using the acceleration switch in the measurement mode.

As a first modification, a case of performing the operation using the acceleration switch at the measurement mode in the pedometer 100 will be described. In this case, the operation may be performed during the measurement of the number of steps, that is, the vibration determination section 303 may detect that the acceleration switch has been operated while detecting the body motion. Thus, as previously described, the threshold value storage section 305 stores the threshold values P1, P2 used to determine whether or not the acceleration of the displacement of the main body 110 is due to body motion in addition to the threshold value P used to determine whether or not the acceleration of the displacement of the main body 110 is the acceleration caused by the operation of the acceleration switch. The vibration determination section 303 preferably determines whether there is body motion of the measurement target, and whether the acceleration switch has been operated from the amplitude of the acceleration waveform of the inputted sensor signal.

When the setting process using the acceleration switch is performed even in the measurement mode in the pedometer 100, the mode storage section 313 preferably stores the mode transition as shown with a dotted line in FIG. 7. In other words, when the set switch 117A is pressed in the “measurement mode”, it is preferably defined to transition from the “measurement mode” to the “hour change mode”.

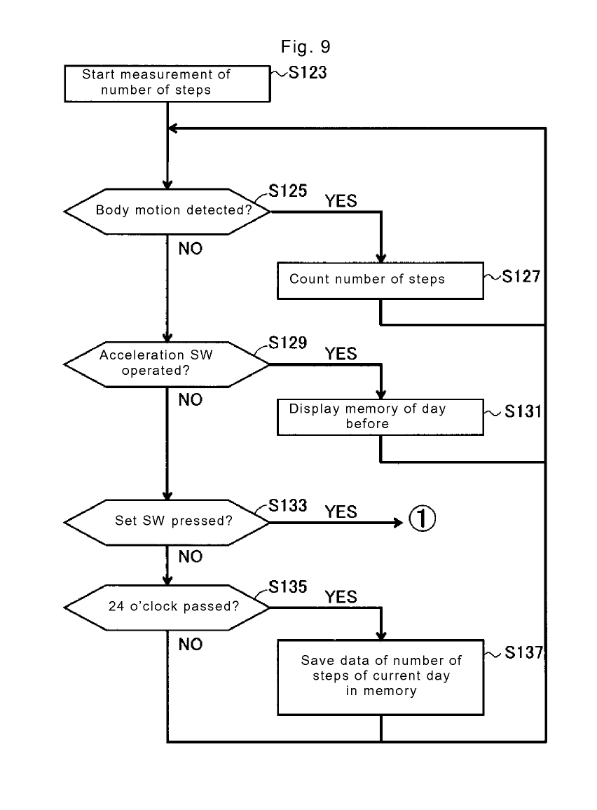

FIG. 9 is a flowchart showing a specific example of the operation process of when performing the operation of displaying various information (specifically, a measurement result herein) stored in a predetermined region of the memory 163 using the acceleration switch during the measurement mode in the first modification. The process shown in the flowchart of FIG. 9 is also the process executed when the battery is inserted to the pedometer 100 and the power is turned ON, and is realized by having the CPU 162 read out and execute the program stored in the memory section 163, and control each section shown in FIG. 5. The process shown in the flowchart of FIG. 9 is the process following the process shown in the flowchart of FIG. 8 when the setting process using the acceleration switch described above is also performed in the pedometer 100.

With reference to FIG. 9, when transitioned to the “measurement mode” in step S123, and the measurement of the number of steps is started, the vibration determination section 303 monitors the acceleration waveform obtained from the sensor signal inputted from the sensor signal input section 301 (steps S125, S133).

When the vibration determination section 303 detects that the amplitude of the acceleration waveform is within the range from the threshold value P1 to the threshold value P2, and determines that there is body motion of the measurement target (YES in step S125), the number-of-steps processing section 307 performs the process of counting and displaying the number of steps, and the process of calculating the ratio of the counted number of steps with respect to the set target value (step S127).

When the vibration determination section 303 detects that the amplitude of the acceleration waveform is not less than the threshold value P, and determines that the acceleration switch has been operated (NO in step S125, YES in step S129), the operation and setting section 309 reads out from a predetermined region of the memory 163 various information such as the measurement result of the day before the day corresponding to the information currently being displayed, and displays the same on the display section 116 (step S131). In the operation process, the operation and setting section 309 reads out from a predetermined region of the memory 163 various information such as the measurement result of the day before the day corresponding to the information being displayed, and displays the same on the display section 116 every time the operation of the acceleration switch is detected by the vibration determination section 303. That is, various information such as the measurement result of the days before of the number of times the acceleration switch has been operated are displayed on the display section 116.

When the operation signal is inputted as a result of the set switch 17A being pressed by the operation signal input section 311 in the “measurement mode” (YES in step S133), the “measurement mode” transitions to the “hour change mode” according to the mode transition stored in the mode storage section 313, and then stored in the mode storage section 313. The process then proceeds to step S103 of FIG. 8.

When timed that the current time has passed 24 o'clock by the timing means (not shown) arranged in the arithmetic circuit 162a (YES in step S135), information on the number of steps for the current day calculated and obtained in the arithmetic circuit 162a is saved in the predetermined region of the memory 163 (step S137).

In the above specific example, the operation process of displaying the stored measurement result using the acceleration switch during the measurement mode is shown, but it may also be the operation process of displaying the amount of exercise such as the consumed calories calculated from the number of steps, the walking distance, the burning fat amount, the walking speed, the walking pitch, the exercise intensity, and the number of steps of when walking at a certain exercise intensity or more from a predetermined time (e.g., measurement start time of current day etc.) to an operation time point. The operation process of switching two or more of such displays using the acceleration switch may be performed.

When such an operation process is performed in the pedometer 100 according to the first modification, the number of switches necessary for the operation becomes less than in the pedometer for performing the operation process using the switch of the related art. The above-described process can be realized without newly adding a configuration for operation process since the body motion detection sensor 150A for detecting the body motion in the pedometer is also used for the operation process. This contributes to miniaturization and lower cost.

As the operation is the combination of the pressing of the set switch 117A and the shaking of the pedometer 100 in a predetermined direction, the operation is easier than the operation of the conventional pedometer in which a plurality of switches are pressed for different purposes. Therefore, a pedometer that is easy to use for wide range of users can be provided.

### [Second Modification]

In the above description, the change in acceleration when the main body 110 displaces is detected by shaking the main body 110 of the pedometer 100 in a predetermined direction (direction of arrow A in FIG. 3), and the setting process and the operation process is performed according to the presence of change in acceleration. However, in the second modification, the setting process and the operation process may be performed by detecting the number of times to shake the main body 110, a shaking interval, or a shaking speed (strength), or by combining the above.

For instance, the threshold value storage section 305 further stores a threshold value P3 for detecting rapid shaking as the operation of the acceleration switch. The vibration determination section 303 may determine that the acceleration switch is operated by slowly shaking when detecting that the amplitude of the acceleration waveform is greater than the threshold value P and smaller than the threshold value P3, and that the acceleration switch is operated by rapidly shaking when detecting that the amplitude is greater than the threshold value P3. When the vibration determination section 303 makes such determination, for example, when selecting the set value of “hour” and “minute” according to the operation of the acceleration switch in step S109 and step S119, the operation and setting section 309 may perform the process of adding a normal constant interval (by 1 herein) and displaying the same when rapid shaking is detected, and adding a value smaller than 1 (e.g., by 0.5) and displaying the same when slow shaking is detected. On the contrary, the process of adding a value greater than 1 (e.g., by 2) and displaying the same when rapid shaking is detected, and adding a normal constant interval (by 1 herein) and displaying the same when slow shaking is detected may be performed.

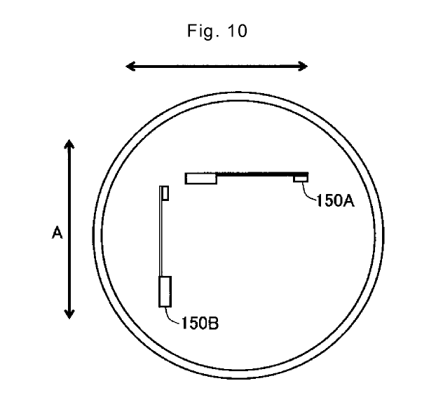

The pedometer 100 according to the second modification may have a configuration schematically shown in FIG. 10, for example. FIG. 10 shows a configuration described in Japanese Unexamined Patent Publication No. 9-223214 filed and publicized before by the applicant of the present application, the configuration includes a body motion detection sensor 150B for detecting the displacement of the main body 110 in a direction B different from a direction A in addition to the body motion detection sensor 150A for detecting the displacement of the main body 110 in the direction A, described above, in the sensor unit 150. When the pedometer 100 has the configuration shown in FIG. 10, the displacement of the main body 110 in each direction of the direction of the arrow A and the direction of the arrow B in FIG. 10 is detected. Alternatively, the sensor unit 150 may include three or more body motion detection sensors so that the pedometer 100 detects the displacement of the main body 110 in three or more different directions. In the pedometer 100 of such a configuration, the setting process and the operation process may be performed by combining the change in acceleration of the displacement of the main body 110 in the direction A and the change in acceleration of the displacement of the main body 110 in the direction B. That is, the setting process and the operation process may be performed by combining the operation of an acceleration switch A caused by shaking in the direction A and the operation of an acceleration switch B caused by shaking in the direction B. Furthermore, the setting process and the operation process may be performed by detecting the number of times to shake, the shaking interval, and the shaking speed in the direction A and/or direction B, or by combining the above.

Through such a setting process and an operation process, the types of operations increase, and thus the user can instruct transition to the desired mode, determine the desired set value, or perform the desired operation with less number of operations.

In such a case, detection of one of the number of times to shake the main body 110, the shaking interval, the shaking speed and the like may be changed to the pressing of the set switch 117A. That is, in the pedometer 100 according to the second modification, the setting process and the operation process may be performed using the number of times to shake the main body 110, the shaking interval, the shaking speed, and the like without using the operation signal caused by the pressing of the set switch 117A. Thus, the set switch 117A may not be arranged in the pedometer 100 according to the second modification. Furthermore, one of either the acceleration switch A or the acceleration switch B may be used as the set switch 117A, and the set switch 117A may not be arranged in the pedometer 100 according to the second modification. This contributes to further miniaturization and lower cost. Since the operation is to shake the pedometer 100 in a predetermined direction, the operation is easier than the operation of the conventional pedometer that uses a switch. Therefore, a pedometer that is easy to use for wide range of users can be provided.

The embodiments disclosed herein are illustrative in all aspects and should not be construed as being restrictive. The scope of the invention is defined by the claims rather than by the description made herein, and all modifications are intended to be encompassed within the meaning and the scope equivalent to the claims.

1-10. (canceled)

11. A body motion detection device comprising:
a main body;
an acceleration sensor configured to detect an acceleration of the main body;
a storage section configured to store a range of acceleration and a threshold value greater than the range of acceleration;
a vibration determination section configured to determine that the detected acceleration corresponds to body motion when the detected acceleration is within the range of acceleration and to determine that the detected acceleration corresponds to input for a setting operation when the detected acceleration is greater than the threshold value;
a body motion detecting section configured to detect the body motion based on the detected acceleration when determined that the detected acceleration corresponds to body motion;
a counting section configured to increment, upon detection of the body motion, a number corresponding to an amount of detected body motion; and
a setting operation section configured to perform the setting operation when determined that the detected acceleration corresponds to input for the setting operation.

12. The body motion detection device of claim 11, further comprising:
a memory,
wherein the setting operation section is further configured to set in the memory at least one of a current time, body information of a subject, and a target value for an amount of exercise calculated based on the number corresponding to the amount of detected body motion.

13. The body motion detection device of claim 12, wherein
a first item and a second item are provided as targets to be set, and
the setting operation section is further configured to proceed to setting of the second item when determined that the detected acceleration corresponds to input for the setting operation while setting the first item.

14. The body motion detection device of claim 12, wherein
the setting operation section comprises a presenting section configured to present a first value of an item to be set,
the presenting section is further configured to present a second value instead of the first value when determined that the detected acceleration corresponds to input for the setting operation while presenting the first value,
the storage section is further configured to store a second threshold value greater than the threshold value, and
a difference between the first value and the second value when the detected acceleration is greater than the threshold value and smaller than the second threshold value differs from a difference between the first value and the second value when the detected acceleration is greater than both the threshold value and the second threshold value.

15. The body motion detection device of claim 11, further comprising:
a display section,
wherein the setting operation section is further configured to switch a display on the display section from first information to second information when determined that the detected acceleration corresponds to input for the setting operation while the first information is displayed on the display section.

16. The body motion detection device of claim 15, wherein the first information and the second information, respectively, comprise at least one of a current time, body information of a subject, and an amount of exercise calculated based on the number corresponding to the amount of detected body motion.

17. The body motion detection device of claim 12 or 16, wherein the amount of exercise comprises at least one of a number of steps, a consumed calorie, a walking distance, a burning fat amount, a walking speed, a walking pitch, an exercise intensity, and a number of steps when walking at or above an exercise intensity.

18. The body motion detection device of claim 12 or 16, wherein the body information comprises at least one of a weight, a height, a stride, an age, and a gender.

19. The body motion detection device of claim 11, wherein
the acceleration sensor comprises a first acceleration sensor configured to detect acceleration in a first direction and a second acceleration sensor configured to detect acceleration in a second direction, and
the setting operation section is configured to perform a first setting operation corresponding to acceleration in the first direction and a second setting operation corresponding to acceleration in the second direction.

20. The body motion detection device of claim 11, further comprising:
a button,
wherein the setting operation section is configured to perform the setting operation based on the input for the setting operation and input via the button.
